(19) United States
(12) Patent Application Publication
(10) Pub. No.: US 2012/0089302 A1
(43) Pub. Date: Apr. 12, 2012

(54) ILLUMINATED SEAT BELT RECEPTACLE

(76) Inventor: John A. Griffin, Forest Hill, MD (US)

(21) Appl. No.: 12/899,050

(22) Filed: Oct. 6, 2010

(51) Int. Cl. B60R 22/18; G06F 19/00; B60R 22/00

(52) U.S. Cl. 701/45

(57) ABSTRACT

A seat belt system for a vehicle may include a plurality of seat belt assemblies each including a seat belt receptacle, a light source for selectively illuminating the receptacle, and a latch mechanism for releasably latching a seat belt buckle to the receptacle. A controller may be operatively associated with the light source, the latch mechanism sensor, a transmission gear position sensor, and at least one of a door position sensor, engine sensor and air bag sensor. The controller may operably process signals received from the sensors and direct the light source to selectively illuminate the seat belt receptacle in various operational conditions of the vehicle.

### FIELD

The present disclosure relates generally to a seat belt assembly, and more particularly to a seat belt assembly having an illuminated seat belt receptacle.

### BACKGROUND

Conventional seat belt systems in today's automotive vehicles typically include a belt or webbing portion and a tongue configured to be detachably secured in a receptacle to secure the webbing portion across a vehicle occupant so as to restrain the occupant from movement in various circumstances. These seat belt systems may also include a lighting arrangement to assist in locating the receptacle. The lighting arrangements can be configured to turn on when a vehicle door is opened and turn off when the tongue is secured in the receptacle. While these seat belt systems and lighting arrangements work for their intended purpose, there remains a need for continuous improvement in the relevant art.

### SUMMARY

In one form, a seat belt system for a vehicle is provided. The seat belt system can include a plurality of seat belt assemblies each including a seat belt receptacle, a light source and a latch mechanism sensor. The seat belt receptacle includes a light transmitting portion and a latch mechanism for releasably latching a seat belt buckle to the receptacle. The latch mechanism sensor can be operatively associated with the latch mechanism. The light source can be positioned and configured to selectively illuminate the light transmitting area. A controller can be operatively associated with the light source and latch mechanism sensor of each seat belt assembly, as well as a door position sensor and a gear position sensor. The door position sensor can be operatively associated with a door of the vehicle and the gear position sensor can be operatively associated with a transmission of the vehicle. The controller can be operable to process a signal from the door position sensor indicative of the door being opened and direct the light source to illuminate the light transmitting area of each seat belt receptacle. The controller can also be operable to process a signal from the latch mechanism sensor indicative of at least one of the seat belt buckles being releasably latched in at least one respective seat belt receptacle and cause the light source to turn off the illumination of the light transmitting area of the at least one receptacle. The controller can be further operable to turn off the illumination of any remaining seat belt receptacles that are not releasably latched to a respective buckle when the controller receives a signal from the gear position sensor indicative of the transmission being in a gear other than park.

In another form, a seat belt system for a vehicle is provided and can include a plurality of seat belt assemblies that each includes a seat belt receptacle, a light source and a latch mechanism sensor. The seat belt receptacle includes a light transmitting area and a latch mechanism for releasably latching a seat belt buckle to the receptacle. The light source can be positioned and configured to selectively illuminate the light transmitting area. The latch mechanism sensor can be operatively associated with the latch mechanism. A controller can be operatively associated with the light source and latch mechanism sensor of each seat belt assembly, as well as a gear position sensor, an engine sensor and an air bag sensor. The gear position sensor can be operatively associated with a transmission of the vehicle; the engine sensor can be operatively associated with an engine of the vehicle; and the air bag sensor can be operatively associated with an air bag of the vehicle. The controller can be operable to illuminate the light transmitting area of each seat belt receptacle that is determined to be latched to a respective seat belt buckle via the latch mechanism sensor upon receipt of a signal from the engine sensor indicative of an engine stall event, or receipt of a signal from the air bag sensor indicative of an air bag of the vehicle being deployed.

### DRAWINGS

The present disclosure will become more fully understood from the detailed description, the appended claims and the following drawings. The drawings are for illustrative purposes only and are not intended to limit the scope of the present disclosure.

FIG. 1 is a perspective view of an exemplary seat belt assembly according to the principles of the present disclosure;

FIG. 2 is a schematic representation of a control arrangement associated with the seat belt assembly of FIG. 1 according to the principles of the present disclosure;

FIG. 3 is a flowchart illustrating an exemplary operation of the control arrangement of FIG. 2 according to the principles of the present disclosure; and

FIG. 4 is a flowchart illustrating another exemplary operation of the control arrangement of FIG. 2 according to the principles of the present disclosure.

### DETAILED DESCRIPTION

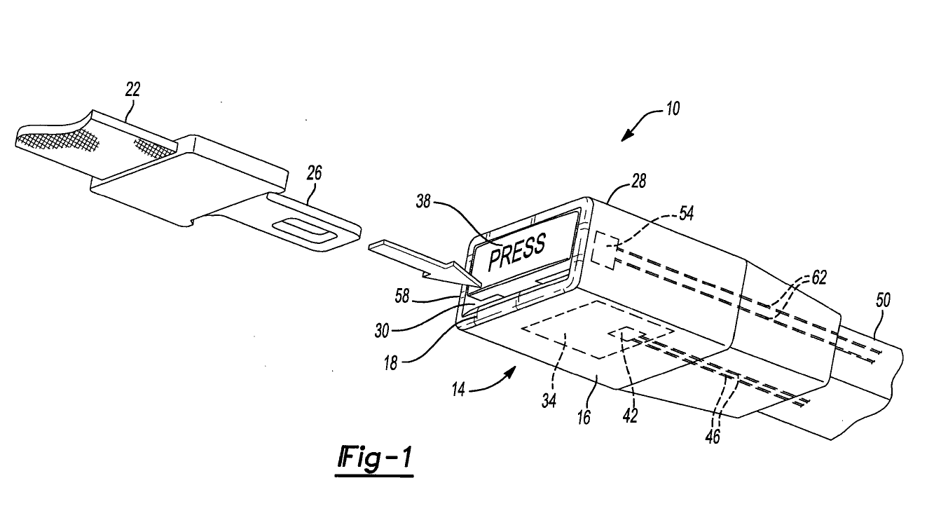

With initial reference to FIG. 1, a seat belt assembly 10 is provided for use in a vehicle. The seat belt assembly 10 can include a receptacle 14 having a light transmitting area 18 and seat belt webbing 22 having a buckle 26 operatively associated therewith. It should be appreciated that the vehicle can include a plurality of seat belt assemblies 10 and the following description will make reference to a seat belt assembly 10 and/or a plurality of seat belt assemblies 10.

The receptacle 14 can include a housing 28 defining an opening 30 for receipt of the buckle 26, and a latch mechanism 34 for locking the buckle 26 to the receptacle 14 in a known manner. The receptacle can include a substantially rectangular shape as shown in FIG. 1, or may be provided in other shapes including an oval or square configuration in cross-section. A release mechanism, such as a pushbutton release 38, can be used to release buckle 26 from the latch mechanism 34 and can be positioned adjacent the opening 30, as also shown in FIG. 1.

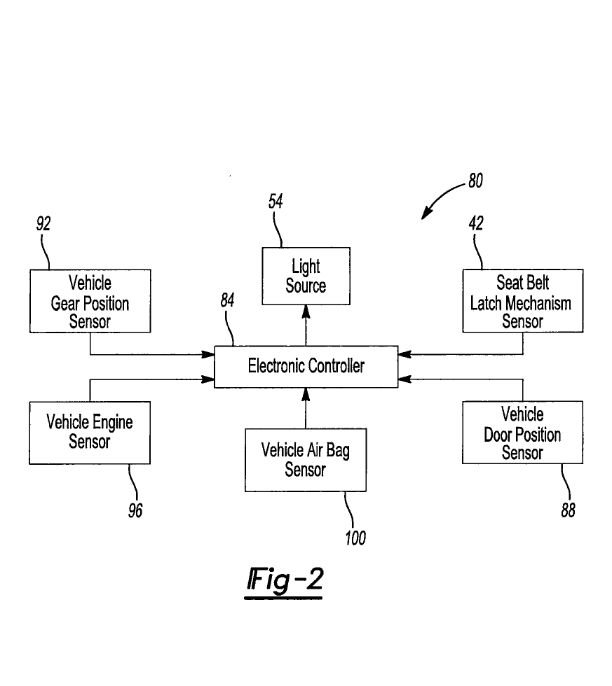

The latch mechanism 34 can include a latch sensor 42 configured to sense whether or not buckle 26 is latched to receptacle 14. Sensor 42 can send a signal via electrical leads 46 to a controller 84 (FIG. 2) indicative of a latched or unlatched condition of buckle 26 relative to receptacle 14. The receptacle 14 can be secured or anchored in a know manner to the vehicle using a securing portion 50 extending from receptacle 14. The electrical leads 46 can be routed from receptacle 14 through securing portion 50, as shown in FIG. 1.

The light transmitting area 18 can be formed of a translucent material such that selective illumination from a light source 54 can be transmitted therethrough for enabling a vehicle occupant or other persons in the vehicle to locate seat belt receptacle 14 as well as the opening 30 and release mechanism 38. It should be appreciated that while the light transmitting area 18 is shown extending around a top perimeter 58 of receptacle 14, light transmitting area 18 can be positioned in other locations on receptacle 14 suitable for illuminating opening 30 and release mechanism 38. In an exemplary configuration, the light transmitting area 18 can be formed of a clear or substantially clear translucent material, or can be tinted with various colors. Light source 54 can be any suitable source capable of providing adequate illumination of the opening 30 and release mechanism 38 discussed above, including an incandescent bulb or a light emitting diode (LED), fiber optics, etc. Electrical leads 62 can extend from light source 54 through receptacle 14 and securing portion 50 to controller 84.

With additional reference to FIG. 2, a control arrangement 80 operatively associated with the seat belt assemblies 10 and the vehicle will now be described in greater detail. The control arrangement 80 can include mechanical, electrical, computer hardware and software components and combinations thereof. Control arrangement 80 can include a controller 84 and can be positioned in the vehicle remote from the seat belt assemblies 10 or can be positioned internal to each of the seat belt receptacles 14. In the illustrated configuration, the controller 84 is positioned remote from receptacles 14 and can be used to control the plurality of seat belt assemblies 10 included in the vehicle, one for each seating position. It should be appreciated, however, that in an alternative configuration, the controller 84 could be positioned within receptacle 14 of each seat belt assembly 10 included in the vehicle, with the electrical leads 46, 62 routed within receptacle 14 to controller 84.

The controller 84 can be configured to receive inputs from various sensor arrangements and process the inputs to selectively power light source 54, or direct another component to power the light source 54, and thereby selectively illuminate light transmitting area 18 of receptacle 14. In this manner, the controller 84 can be coupled to latch mechanism sensor 42, light source 54, a vehicle door position sensor 88, a vehicle gear position sensor 92, a vehicle propulsion device or engine sensor 96, and a supplemental restraint system or air bag deployment sensor 100, as shown in FIG. 2 and described in greater detail below. It should be appreciated that electronic controller 84 can be coupled to fewer or more sensors than discussed immediately above as may be desired for various vehicle and/or seat belt assembly functionality.

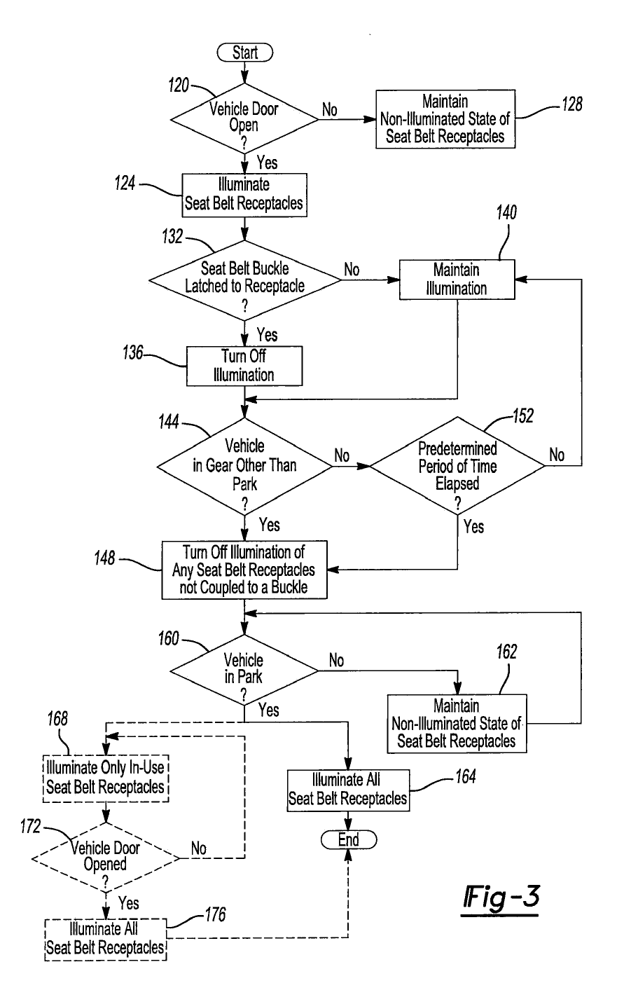

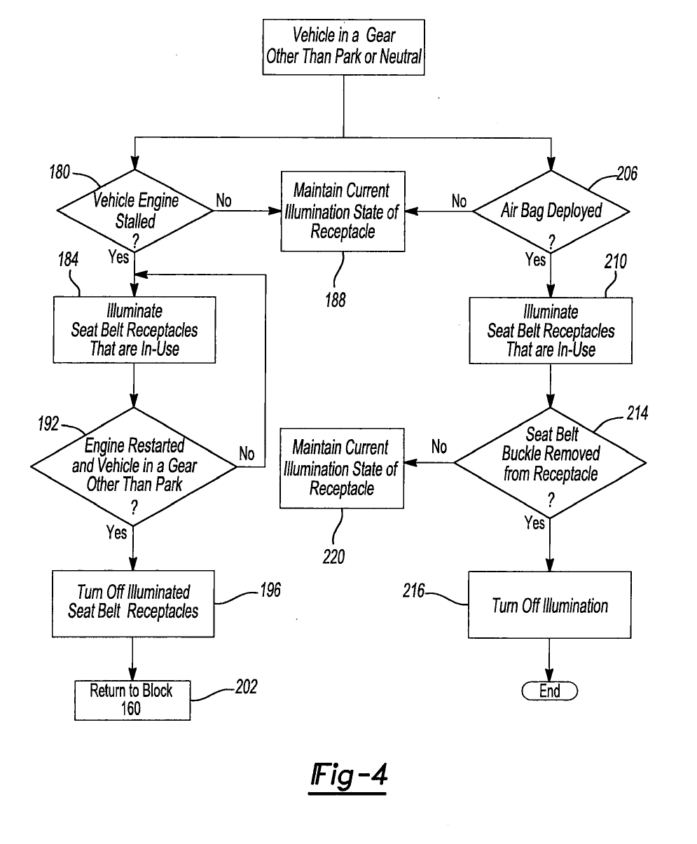

With additional reference to FIGS. 3-4, operation of the controller 84 in connection with the various inputs will now be described. In one exemplary configuration, the controller 84 can be configured to process a signal from the door position sensor 88 in response to a door of the vehicle being opened, as set forth at block 120. When the door is opened, controller 84 can be configured to direct the light sources 54 to illuminate receptacles 14 via light transmitting areas 18, as set forth at block 124. If a door of the vehicle has not been opened, controller 84 can be configured to maintain the non-illuminated state of the light transmitting areas 18, as set forth at block 128.

Controller 84 can be configured to determine if seat belt buckle 26 has been inserted into opening 30 and latched to receptacle 14 via latch mechanism sensor 42, as set forth at block 132. Controller 84 can turn off the illumination of each receptacle 14 in response to a signal from the respective latch mechanism sensor 42 indicating that the corresponding buckle 26 has been latched thereto, as set forth at block 136. If controller 84 has not received such a signal thereby indicating that certain buckles 26 have not been latched to corresponding receptacles 14, the illuminated state of the associated light transmitting areas 18 can be maintained, as set forth at block 140.

If the vehicle transmission has been taken out of a park gear and placed into a reverse or drive gear via a transmission shifter arrangement (not shown), the vehicle gear position sensor 92 can be configured to send a signal indicative of the transmission gear change to controller 84. Controller 84 can process the signal from gear position sensor 92 and, based on a determination that the transmission is a gear other than park at block 144, can turn off the illumination of light source 54 for any of the plurality of seat belt assemblies 10 in the vehicle that are not in use (i.e., where the buckle 26 is not latched to receptacle 14), as set forth at block 148. Controller 84 can also be configured to maintain illumination of seat belts for a predetermined time after the transmission is taken out of park.

If the vehicle remains in park, the controller 84 can be configured to determine if a predetermined period of time has elapsed since the door has been opened, as set forth at blocks 144 and 152. If the predetermined period of time has not elapsed, the controller 84 can be configured to maintain the illumination of the seat belt assemblies 10 not currently in use, as shown by the return to block 140. On the other hand, if controller 84 determines that the predetermined period of time has elapsed, controller 84 can be configured to turn off the illumination of any seat belt assemblies 10 not currently in use, as set forth at block 148.

Once the vehicle is in mobile operation, and thus in a gear other than park, controller 84 can be configured to maintain the non-illuminated state of seat belt assemblies 10 in the vehicle until one or more predetermined events may occur. In this regard, the predetermined events can include a signal from the gear position sensor 92 indicating that the transmission gear has been changed to park after block 148; or a signal from the engine sensor 96 indicating that an engine of the vehicle has stalled while the transmission is in a gear other than park; or a signal from the air bag sensor 100 indicating that an air bag of the vehicle has been deployed.

If the transmission gear has been changed to park, controller 84 can be configured to determine via sensor 92 that the transmission gear state has changed from a gear other than park (e.g., drive or reverse) to park, as set forth at block 160. If the gear has not changed to park, the controller 84 can be configured to maintain the non-illuminated state of the seat belt receptacles 14, as set forth in block 162.

Once the determination has occurred at block 160 that the vehicle is in park, controller 84 can be configured to illuminate all of the seat belt assemblies 10 in the vehicle as set forth at block 164 or, alternatively, only the seat belt assemblies 10 that are currently in use as set forth at block 168. In the alternative configuration where only the seat belt assemblies 10 that are in use are illuminated, controller 84 can be configured to then determine if a door of the vehicle has been opened via door position sensor 88 at block 172. If a door of the vehicle has been opened, controller 84 can be configured to illuminate all of the seat belt assemblies 10 in the vehicle, as set forth in block 176. If a vehicle door has not been opened, controller 84 can be configured to maintain the illumination of the seat belt receptacles 14 of the seat belt assemblies 10 that are in use until either the seat belt assemblies 10 are no longer in use or a predetermined period of time has elapsed between when the vehicle has been placed in park after mobile operation and a door of the vehicle has not been opened.

With particular reference to FIG. 4 and continued reference to FIGS. 1-3, controller 84 can be configured to also selectively illuminate the light transmitting areas 18 of the seat belt receptacles 14 when the vehicle is in a gear other than park or neutral and the engine has stalled and/or an air bag has been deployed, as described in greater detail below.

If the controller 84 determines via engine sensor 96 that the vehicle engine has stalled at block 180, the controller 84 can be configured to illuminate only the receptacles 14 of seat belt assemblies 10 that are in use, as discussed above and set forth at block 184. This operation can be useful in a variety of situations, including an exemplary situation where the engine has stalled and the vehicle is in a position where the occupant(s) desire to leave the vehicle. Illumination of the in-use seat belt receptacles 14 can aid the occupant(s) in quickly finding the respective receptacle 14, especially in a minimum light or dark (i.e., night) condition. As set forth at block 188, if the engine has not stalled as described above, the controller 84 can be configured to maintain the current illumination state of the seat belt receptacles 14.

Continuing with this configuration, if the controller 84 determines that the vehicle engine has been restarted and the transmission has been placed in a gear other than park, controller 84 can be configured to turn off the illumination of the illuminated seat belt receptacles 14, as set forth at blocks 192 and 196. The control process can then continue or return to between blocks 148 and 160 of FIG. 3, as set forth in block 202. Otherwise, if the controller 84 determines that the engine has not been restarted and the transmission has not been placed in a gear other than park, the illumination of the seat belt receptacles 14 that are in use can be maintained. Controller 84 can also be configured to maintain illumination of seat belts for a predetermined time after the transmission has been placed in a gear other than park.

The controller 84 can also be configured to determine if an air bag associated with the vehicle has deployed via air bag sensor 100, as set forth at block 206. If the controller 84 determines that the air bag has deployed, the controller 84 can be configured to illuminate only the seat belt receptacles 14 that are currently in use, as set forth in block 210. Otherwise, the controller 84 can be configured to maintain the current non-illuminated state of the seat belt receptacles 14, as set forth in block 188.

Deployment of an air bag is typically indicative of the vehicle being involved in an impact event and it may be desirable for vehicle occupant(s) and/or emergency personnel to find the in-use seat belt receptacles 14 for efficient egress of the occupant(s) from the vehicle. In this regard, and as discussed above, illumination of only the in-use seat belt receptacles 14 can aid the vehicle occupant(s) and/or emergency personnel to more quickly find the in-use seat-belt receptacles, especially in minimum light conditions.

Continuing with this scenario where the air bag has deployed, the controller 84 can be configured to determine if an in-use seat belt assembly 10 has been unlatched subsequent to the air bag deployment and turn off the illumination of that seat belt receptacle 14, as set forth in blocks 214 and 216. Otherwise, controller 84 can be configured to maintain the illuminated state of the in-use receptacle or receptacles 14, as set forth in block 220.

As discussed above with reference to blocks 180 and 206 of FIG. 3, controller 84 can be configured to illuminate the seat belt receptacles 14 that are in use responsive to the engine stalling or the air bag deploying. In this regard, it should be appreciated that one or both of these events can occur in various situations. In a scenario where both events occur, it should also be appreciated that the events can occur concurrently or in series. For example, if both events occur, the controller 84 can be configured to use the air bag deployment as the controlling event and follow the control operation as described in connection with blocks 206-220.

While one or more specific examples have been described and illustrated, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof.

What is claimed is:

1. A seat belt system for a vehicle, comprising:
a plurality of seat belt assemblies, each seat belt assembly including:
a seat belt receptacle having a light transmitting area and a latch mechanism for releasably latching a seat belt buckle to the receptacle;
a light source positioned and configured to selectively illuminate the light transmitting area; and
a latch mechanism sensor operatively associated with the latch mechanism;
a controller operatively associated with the light source and latch mechanism sensor of each seat belt assembly;
a door position sensor operatively associated with a door of the vehicle and the controller; and
a gear position sensor operatively associated with a transmission of the vehicle and the controller;
the controller operable to process a signal from the door position sensor indicative of the door being opened and direct the light source to illuminate the light transmitting area of each seat belt receptacle, the controller operable to process a signal from the latch mechanism sensor indicative of at least one of the seat belt buckles being releasably latched in at least one respective seat belt receptacle and direct the light source to turn off the illumination of the light transmitting area of the at least one receptacle, and the controller further operable to turn off the illumination of any remaining seat belt receptacles that are not releasably latched to a respective buckle when the controller receives a signal from the gear position sensor indicative of the transmission being in a gear other than park.

2. The seat belt system of claim 1, wherein each seat belt receptacle further comprises a release mechanism, the light transmitting area being positioned adjacent the release mechanism.

3. The seat belt system of claim 2, wherein the light transmitting area is integrally formed with a housing for the receptacle and the light transmitting area surrounds a perimeter of the release mechanism.

4. The seat belt system of claim 1, wherein the controller is operable to turn off the illumination of the light transmitting areas of the remaining seat belt receptacles that are not releasably latched to a respective buckle after a predetermined period of time has elapsed and the vehicle gear position sensor indicates that the vehicle transmission is in the park gear.

5. The seat belt system of claim 1, further comprising an engine sensor operatively associated with the controller and an engine of the vehicle, the controller operable to receive a signal from the engine sensor indicative of an engine stall event and direct the light transmitting area of each of the seat belt receptacles having a seat belt buckle latched therein to be illuminated.

6. The seat belt system of claim 5, wherein upon the controller receiving the signal indicative of the engine stall event, the controller directs the light transmitting area of each of the seat belt receptacles having a seat belt buckle latched therein to be illuminated if the vehicle transmission is in a gear other than the park gear.

7. The seat belt system of claim 1, wherein the controller is operable to direct the light transmitting area of each of the seat belt receptacles releasably latched to a respective buckle to be illuminated upon the controller receiving a signal from the vehicle gear position sensor indicative of the transmission being placed into the park gear after mobile operation of the vehicle with the transmission being in a gear other than park.

8. The seat belt system of claim 1, further comprising an air bag sensor operatively associated with the controller and an air bag of the vehicle, the controller operable to direct illumination of the light transmitting area of each seat belt receptacle releasably latched to a respective buckle upon receiving a signal from the air bag sensor indicative of deployment of the air bag.

9. The seat belt system of claim 8, wherein the controller is operable to turn off the illumination of the light transmitting area of any seat belt receptacle where the respective seat belt buckle is removed after deployment of the air bag.

10. A seat belt system for a vehicle, comprising:
a plurality of seat belt assemblies, each seat belt assembly including:
a seat belt receptacle having a light transmitting area and a latch mechanism for releasably latching a seat belt buckle to the receptacle;
a light source positioned and configured to selectively illuminate the light transmitting area; and
a latch mechanism sensor operatively associated with the latch mechanism;
a controller operatively associated with the light source and latch mechanism sensor of each seat belt assembly;
a gear position sensor operatively associated with a transmission of the vehicle and the controller;
an engine sensor operatively associated with the controller and an engine of the vehicle; and
an air bag sensor operatively associated with the controller and an air bag of the vehicle;
the controller operable to illuminate the light transmitting area of each seat belt receptacle determined to be latched to a respective seat belt buckle via the latch mechanism sensor upon receipt of a signal from the engine sensor indicative of an engine stall event, or receipt of a signal from the air bag sensor indicative of the air bag being deployed.

11. The seat belt system of claim 10, wherein the controller is operable to individually maintain the illumination of the light transmitting area of each respective seat belt receptacle that is determined to be latched after receipt of either the signal indicative of the engine stall event or the signal indicative of the air bag being deployed until receipt of a signal from the latch mechanism sensor of each latched respective seat belt receptacle indicative of the corresponding seat belt buckle being released therefrom.

12. The seat belt system of claim 10, wherein the controller is operable to illuminate the light transmitting area of each seat belt receptacle determined to be latched upon receipt of both the signal indicative of the engine stall event and a signal from the gear position sensor indicative of a transmission of the vehicle being in a gear other than a park gear.

13. The seat belt system of claim 10, wherein the controller is operable to turn off the illumination of the illuminated light transmitting areas that have been illuminated in response to an engine stall event upon receipt of a signal from the engine sensor that the engine has been started subsequent to the engine stall event and a signal from the gear position sensor indicative of the transmission being in a gear other than a park gear.

14. The system of claim 13, wherein upon receipt of both the signal from the engine sensor indicative of the engine stall event and the signal from the air bag sensor indicative of the air bag deployment, the controller is operable to maintain the illumination of the light transmitting areas of the seat belt receptacles determined to be latched even if the controller determines that the engine has been restarted and the vehicle is in a gear other than the park gear.

15. The seat belt system of claim 10, further comprising a door position sensor operatively associated with the controller and a door of the vehicle;
wherein the controller is operable to process a signal from the door position sensor indicative of the door being opened and direct the light source to illuminate the light transmitting area of each seat belt receptacle, the controller is also operable to process a signal from the latch mechanism sensor indicative of at least one of the seat belt buckles being releasably latched in at least one respective seat belt receptacle and direct the light source to turn off the illumination of the light transmitting area of the at least one receptacle.

16. The seat belt system of claim 15, wherein the controller is further operable to turn off the illumination of any remaining seat belt receptacles that are not releasably latched to a respective buckle when the controller receives a signal from the gear position sensor indicative of the transmission being in a gear other than park.
